(19) United States
(12) Patent Application Publication
(10) Pub. No.: US 2010/0031145 A1
(43) Pub. Date: Feb. 4, 2010

(54) System and Method for Wireless Transfer of Content and/or Data Between Multimedia Devices

(76) Inventors: John Haggis, San Jose, CA (US); John Glissman, Mountain View, CA (US); Arthur Cohen, Mountain View, CA (US)

Correspondence Address: STAINBROOK & STAINBROOK, LLP, 412 AVIATION BOULEVARD, SUITE H, SANTA ROSA, CA, 95403, US

(21) Appl. No.: 11/721,319

(22) PCT Filed: Feb. 27, 2007
(86) PCT No.: PCT/US07/62910

§ 371 Date: Jun. 8, 2007

Related U.S. Application Data
(60) Provisional application No. 60/777,049, filed on Feb. 27, 2006.
(60) Provisional application No. 60/747,995, filed on May 23, 2006.
(60) Provisional application No. 60/806,076, filed on Jun. 28, 2006.

(51) Int. Cl. G06F 17/00; G06F 3/048; G06F 15/16; G06F 12/00

(52) U.S. Cl. 715/716; 709/217; 709/203; 715/748; 711/103; 700/94; 711/E12.001

(57) ABSTRACT

A method and apparatus for streaming and/or transferring data and/or content between a source multimedia player (SMP) having mass storage and at least one destination multimedia player (DPM), including SMP connection means for bringing the inventive apparatus into either wired or wireless communication with the SMP using a selected transfer medium; a user interface and identification and selection software for identifying content on the SMP mass storage for extraction; file extraction software for extracting the content from mass storage on the SMP; input hardware for receiving content data from the SMP; formatting or storage software for formatting the extracted content into a format suitable for transmission to a DMP or for storing the content to internal or external flash memory for later transmission to one or more DMPs; transmission hardware for transmitting the formatted content, or transferring the stored content, to DMPs; and DMP connection means for bringing the inventive apparatus into wired or wireless communication with one or more DMPs.

### BACKGROUND OF THE INVENTION

1. Technical Field

The present invention relates generally to digital information transmission, and more particularly to a method of wired or wireless transfer of digital or analog content and/or data between multimedia devices.

2. Background Art

The popularity of handheld multimedia players combined with the widespread use of the Internet has largely “virtualized” multimedia content delivery. Content is now routinely downloaded, uploaded, streamed, and ripped, and eventually finds its way to a user's portable multimedia player for use when convenient. Publicity is shifting from organized advertising and studio/radio-station profile control to fast paced spread and transmission though on-line communities, word-of-mouth, and guerilla marketing. End-users are electing to listen to music and to make music purchases through on-line music subscription services, rather than listening to conventional radio and purchasing at brick-and-mortar record stores.

In this climate of nearly instantaneous access to data and other kinds of electronic file content, a growing number of people are seeking new media from friends and other trusted sources. In the past, this took the form of taking recommendations on individual songs and artists. It has evolved, however, into large size digital library and playlist sharing through electronic means. There is significant pressure to improve automatic transmission of this information to satisfy consumer needs. Multiple approaches to this data transfer task are presented in this application.

As used herein, the term “multimedia player” can mean any electronic device utilizing computer software for playing back multimedia files, whether portable or relatively fixed, though the present invention is largely adapted for use with portable multimedia players. Generally speaking most current software media players support audio and video files in several media formats, as well as digital image formats and interactive media. These may include such video formats as MPEG, DivX, XviD and SMV; audio formats currently include MP3, WAV, and Ogg Vorbis; digital image formats can include BMP, JPEG, and GIF; and the most common interactive media formats include Adobe Flash and Flash LITE.

### DISCLOSURE OF INVENTION

Consumers who own personal data assistants (PDAs) are familiar with IrDA interfaces and techniques for transferring electronic data from one PDA to another electronic device through the use of a “beaming” process, i.e., a short range exchange of data using infrared light. The present invention is directed to a method and apparatus for applying beaming and streaming data transfer principles to data and other kinds of content typically stored by portable handheld multimedia players.

In connection with the use of multimedia players, and the digital information stored therein, the transfer medium employed in the present invention can take several forms. Preliminarily, it should be noted that for the purposes of the present application, the terms “transfer” and “streaming” are used interchangeably, though streaming may also be understood herein to mean a technique for transferring data that can be processed by a recipient device as a steady and continuous data stream, usually in real time. Overall, the possible transfer media include:

(a) Infrared (either IrDA or FIR);

(b) BLUETOOTH®;

(c) low-power custom digital radio modulation on 400 MHz, 900 MHz, 2.4 GHz, or 15 other bands for unlicensed, short-range digital modulation;

(d) low-power analog radio modulation on 900 MHz, 2.4 GHz, or other bands for unlicensed, short-range analog modulation;

(e) direct connection with cables, pigtails, or integral plugs; and

(f) external memory module transfer from one player to another.

[BLUETOOTH is a registered certification mark of Bluetooth SIG, Inc., of Bellevue, Wash.]

One advantage of the infrared (IrDA) medium over the RF medium is that infrared affords the sender a degree of control over who can receive the infrared transmission. In prior applications of PDA “beaming” this has been considered an important feature because it allows implicit pairing without the need for an extra user-interface. Fast infrared protocol (FIR) is preferable to standard IrDA because it greatly increases the maximum transfer speed, which is highly desirable when dealing with sizeable content. Direct connections, while adding the relative inconvenience of maintaining a physical connection throughout the transfer, have high security and the fastest transfer rates. In some applications the RF interface is most desirable because the transmitter and receiver need not be in close proximity.

In the case of one-to-one transfers in any medium, some kind of pairing process is necessary. In the case of one-to-many streaming, no pairing is necessary if the broadcast model is used.

The preferred embodiments of the inventive wired/wireless data and/or content transfer system described herein include the following: (1) IrDA Beaming; (2) RF Transfer; (3) RF Streaming; (4) Internal-Memory Transfer; (5) External-Memory Transfer; and (6) Direct Interconnect.

The advantages of the present invention will become readily apparent to those skilled in this art from the following detailed description, which shows and describes only the preferred embodiments of the invention, simply by way of illustration of the best modes now contemplated of carrying out the invention. As will be realized, the invention is capable of modification in various obvious respects without departing from the invention. Accordingly, the drawings and description of the preferred embodiments are to be regarded as illustrative in nature, and not as restrictive.

### BRIEF DESCRIPTION OF THE DRAWINGS

FIG. 1 is a block diagram showing a first preferred embodiment of the software and data architecture of the inventive transfer system, namely an IrDA beaming system;

FIG. 2 is a block diagram showing the transfer device hardware implementing the transfer system of FIG. 1;

FIG. 3 is a block diagram showing the software and data architecture of an alternative embodiment of the inventive system, namely an internal memory transfer system;

FIG. 4 is a block diagram showing hardware implementing the method of FIG. 3;

FIG. 5 is a block diagram showing the software and data architecture of an external memory transfer system of the present invention;

FIG. 6 is a block diagram showing the hardware for implementing the system of FIG. 5;

FIG. 7 is a block diagram showing the software and data architecture for a direct-connection approach to using the inventive method;

FIG. 8 is a block diagram showing the associated hardware thereof; and

FIG. 9 is a block diagram showing the software and hardware employed in an RF analog streaming embodiment of the inventive method.

### BEST MODE FOR CARRYING OUT THE INVENTION

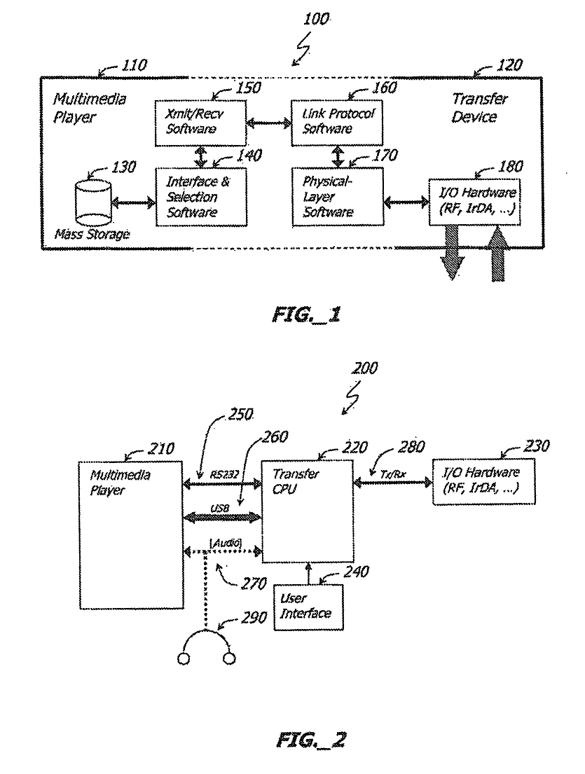

Referring to FIGS. 1-9, there is illustrated the preferred embodiments of the inventive method and apparatus for wired and/or wireless transfer of content and/or data between multimedia players. In respect of FIGS. 1-8, even numbered drawings show software and data architecture of the inventive transfer/streaming system, while each of the odd numbered drawings show complementary hardware for the respective preceding drawing.

Specifically, FIGS. 1, 3, 5, and 7 are block diagrams showing the software and data architecture of the transfer and streaming method and apparatus of the present invention. These views show the functional software blocks and the flow of data distributed between a multimedia player and a transfer device, which is the invention described herein. In these embodiments, all the software modules are contained within a physically discrete device (which for convenience is denominated herein as “transfer device”). The transfer device includes a simple interface to the multimedia player to extract the digital content. Depending on the architecture of a particular multimedia player, one or more of the software blocks may migrate to the CPU in the player. However, regardless of where the processing takes place, the functionality is the same.

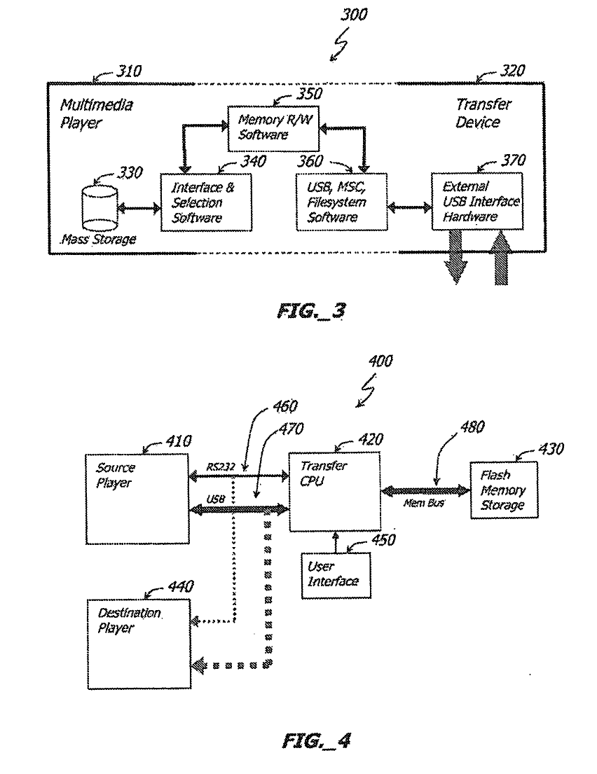

FIGS. 2, 4, 6, and 8 are block diagrams showing the hardware and interfaces included in the transfer device of the present invention. There are small variations in the system depending on the specific embodiment involved.

IrDA Beaming: Referring to FIGS. 1 and 2, there is shown a first preferred embodiment of a transfer method for use in the present invention, namely IrDA beaming. In this first preferred embodiment, the classic PDA beaming strategy is employed, via IrDA or FIR, but applied in an innovative fashion to multimedia players.

Referring first to FIG. 1, the transfer system 100 comprises a multimedia player 110 joined with the transfer device hardware 120. The interface and selection software 140 running on or interacting with the multimedia player identifies a content file residing on the mass storage 130 of the multimedia player. The interface and selection software 140 extracts the file with a high-speed data interface, USB in the case of most players. At the interface software level 140 it interacts directly with the mass storage 130 via FAT [File Allocation Table] filesystem and MSC [Mass-Storage Compliant] or MTP [Media Transfer Protocol] protocols. (It will be appreciated, of course, that FAT filesystem and MSC protocols are but examples of various filesystem and access protocols that may be employed. Accordingly, it will be appreciated by those with skill in the art that the recitation of these are for illustrative purposes only.) The content next passes the data to Transmit/Receive software 150, which breaks the content down into packets and formats it for the IrDA protocol. The IrDA Link-Access Protocol [IR-LAP] software 160 is quite modest. It identifies a recipient in line-of-sight view of the optical transceiver, and establishes a link with it. With this link established, it transmits the data packets through the physical-layer software 170 to modulate the emitter for the IrDA transceiver. The receiving end uses exactly the same elements in reverse. The IR-LAP 160 establishes the connection and mediates the data transfer, which is ultimately written to the player's mass storage 130. A final function of the interface software 140 is to write the file in the correct directory, with the correct file name, and, in the case of certain players, to insert metadata about the file and content in a database on the player, all so that the multimedia player will recognize the content file for playback.

Referring next to FIG. 2, there is illustrated in block diagrammatic form the hardware 200 for the transfer device of FIG. 1. The transfer CPU 220 is the processing element inside the transfer device and carries out the different software tasks in the architecture of FIG. 1. For instance, the selection software 140 communicates with the player 210 to select a particular content file from the mass storage. It uses either the RS232 serial interface 250 if present (notably in the case of an Apple IPOD®). [IPOD® is a registered trademark of Apple, Inc., Cupertino, Calif.]. The USB interface 260, by way of the interface software 140 in FIG. 1, accesses the files in the player 210 via FAT/MSC/MTP or other filesystem and access protocol as described above. The transfer button 240 represents a single button or a more elaborate user interface to select the content file to transfer. Then, by way of the other software elements described above in FIG. 1, the transfer CPU sends the content in packets 280 via the IrDA transceiver 230 to the connected player. For the receiver function, the pass through the hardware is the same in reverse.

RF Transfer: Another embodiment of the invention, also depicted by FIG. 1 and FIG. 2, is the RF transfer strategy. This embodiment is generally identical to the IrDA/FIR “beaming” approach, except that the medium is RF. The content data is modulated onto a radio carrier in one of several possible bands, including but not limited to 400 MHz, 800 MHz, 900 MHz, 2.4 GHz. The choice of band is determined by government regulations in the intended region of use, and as necessary to avoid local interfering sources of ambient RF energy. Since the RF signal will reach any receiving device within range, the link access protocol 160 in FIG. 1 must be adapted to identify and select the intended recipient. This can involve a user-interface operation where the potential recipients are prompted for acceptance of the link, and the sender's device displays a list of potential recipients so the operator may choose the desired one. After the link is established, selection and extraction of the content data 140, formatting, transmission and reception of the packet data 150 are carried out in conventional means. The packet protocol used may be the same as or different from that used in the IrDA/FIR “beaming” approach. The main difference reflects the fact that the data is modulated onto an RF carrier rather than onto an infrared light beam.

RF Streaming: Yet another embodiment of the present invention, again shown in FIGS. 1 and 2, is the RF “live” streaming (broadcast) approach. In this embodiment, the content is extracted via the multimedia player analog interfaces (audio/video/etc.) 140, digitized and formatted as a packet 150, modulated onto the RF carrier 170, and transmitted in a broadcast fashion through the RF transmitter 180. The extraction of analog data is depicted in FIG. 2 by the analog “audio” path 270. In this embodiment, the link access protocol 160 may assign the transmission to an individual recipient as described in the “RF Transfer” approach, above, or else the transmitter may broadcast the signal to any and all recipients with a modest, transparent link access protocol or none at all. In this broadcast model, the user interface 240 may be a simple transmit/receive switch and channel selection. On the receiving end, the process happens in reverse. The user interface 240 selects the receive mode, and the CPU 220 activates the RF receiver 230 and sets the frequency. Then the data is demodulated 170, depacketized 150, and the analog signal is reconstituted through a DAC or Codec internal or external to the CPU 220 through the interface software 140. The analog signal from the receiver 270 routes to a headphone for local listening. It can also route to line inputs 270 on the destination multimedia player if it has recording capabilities.

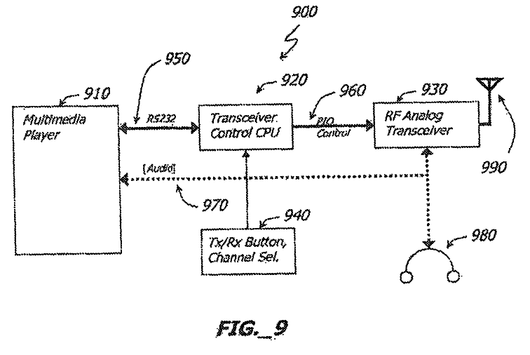

RF Analog Streaming: An alternative embodiment of the present invention, illustrated in FIG. 9, employs an RF analog streaming approach. This embodiment uses a very simple software architecture involved purely in controlling the tuning and operation of RF analog subsystems in the transceiver hardware. The user interface 940 selects the transmit mode, and the CPU 920 activates the RF transmitter and sets the frequency to the channel set by the user interface 940. Analog audio coming from the multimedia player headphone or line-out port 970 feeds into the RF modulator in the transceiver 930, and is then transmitted from the antenna 990. On the receiving end, the user interface 940 selects the receive mode, and the CPU 920 activates the RF receiver and sets the frequency. Analog audio demodulated from the receiver routes to a headphone for local listening. It can also route to line inputs 970 on the multimedia player if it has recording capabilities.

Internal-Memory Transfer: A further embodiment of the invention, illustrated in FIGS. 3 and 4, utilizes an internal-memory transfer approach. Referring now particularly to FIG. 4, the content data is extracted from a source player 410 and stored in flash memory 430 internal to the transfer device through a serial or parallel memory bus 480. The content selection process and interface 340 to extract the content data in FIG. 3 is identical to any of the other approaches described herein, including that previously described in reference to the interface 140 of FIG. 1. The scope and complexity of the user interface 450 depends on the multimedia player resources for selecting transfer content. Once extracted, the content data is written to flash memory and later retrieved by a memory R/W software module 350. To effect the transfer of the content data to another player, the transfer device must be physically detached from the source player 410 and attached to a destination player 440. Then via the USB interface 370 and 470, and the filesystem and protocol software 360, the device transfers the content to the mass storage of the destination player, integrating it into the destination player filesystem or database so as to be recognizable and “playable” by the player.

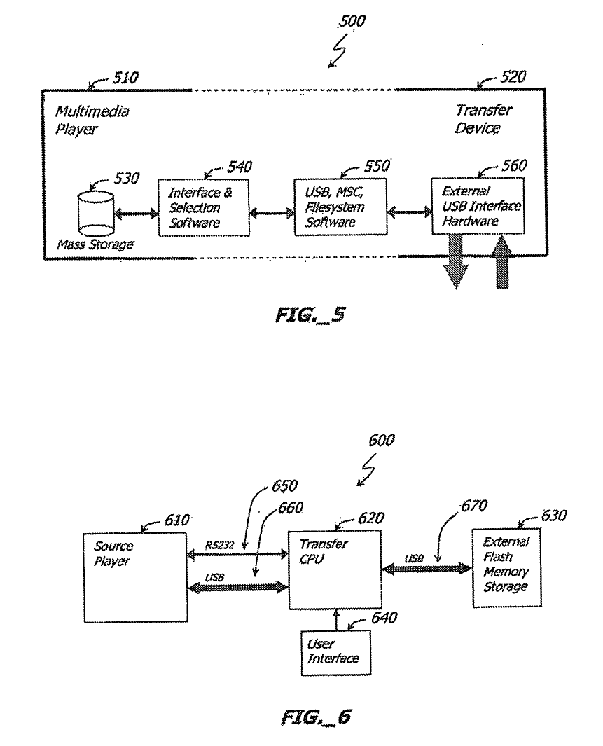

External-Memory Transfer: In still another embodiment of the present invention, shown in FIGS. 5 and 6, the system employs an external-memory approach to content data transfer. Referring now particularly to FIG. 5, this embodiment has a relatively simple architecture, as compared to the others described herein. It has no internal flash memory storage for the content, but rather depends on an external flash USB “drive” accessory. The software architecture includes the standard interface and selection module 540 to extract the content, and it then employs software for a USB flash “drive,” MTP/MSC or other protocol, and FAT or other filesystem 550 to interface to the external drive on the USB port 560. The hardware architecture 600 utilizes the standard interface 640 from the transfer device CPU 620 to the player 610 via USB 660 and possibly RS232 serial 650 for certain players. The scope and complexity of the user interface 640 depends on the multimedia player resources for selecting transfer content. The external USB interface 670 may be shared on a hub with the “internal” USB interface 660 for the player content extraction. The user attaches a USB flash drive to the external USB interface port, selects content and initiates transfer to the USB flash drive with the user interface 640. The user may then provide the flash drive to another user having another transfer device. The second user attaches the flash drive to the USB port on his or her own transfer device and initiates the transfer of the content to a multimedia player using the user interface 640.

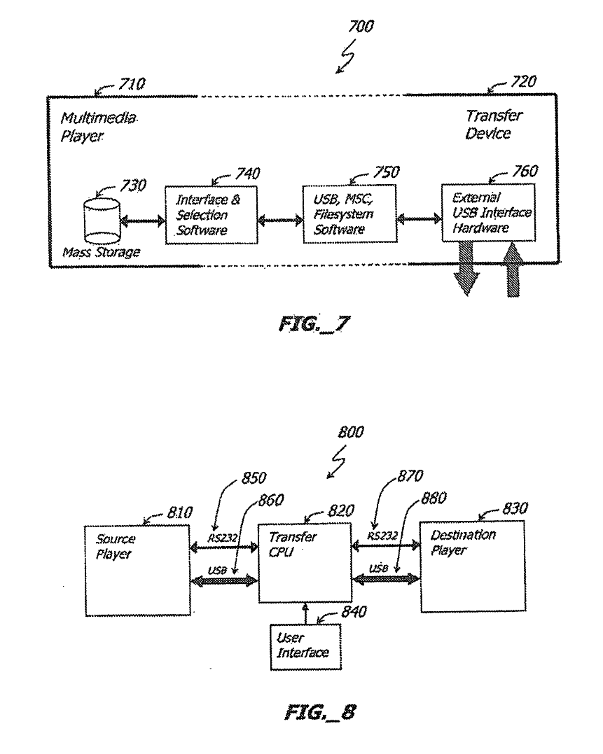

Direct Interconnect: In yet another preferred embodiment of the present invention, shown in FIGS. 7 and 8, the inventive system employs a direct-connection approach. In this embodiment, a source player 810 and a destination player 830 are directly connected to the transfer device 720, which transfers the content from the mass storage 730 of the source player to the mass storage of the destination player. The hardware block diagram 800 depicts this symmetrical transfer method, while the software/data flow block diagram 700 represents it asymmetrically from the point of view of the source player. It hides the USB, MSC, and filesystem on the multimedia player 710 side. If the multimedia player operating system were open to third party development, the transfer device functionality could be integrated to a great degree (if not totally) into the source player. Regardless, the architecture 700 is generally simple. The content originates in the mass storage 730 of the source player 710. Interface and selection software 740 lets the user choose the content to be transferred. Interface and selection software 740 accesses the content file through USB/MSC/MTP/filesystem, then immediately copies it using the same software, OS, and protocol elements 750 through the USB hardware 760 to the mass storage 830 of the destination player.

FIG. 8, showing the hardware architecture 800, provides a more concrete view of this method. It is seen that both the source and the destination multimedia players are connected to the transfer device CPU 820 via USB 860 and 880 for the mass-storage access, and potentially via RS232 serial communications 850 and 870 for handshaking and/or selection functions. Once the selection is made, a user interface control 840 initiates the transfer directly from one player 810 to the other 830.

Although this approach can conceivably be performed currently with a conventional home computer and two cables, and although it has been implemented with bulky standalone devices with cables, the innovative approach of this embodiment of this invention is in integrating the player-interface connectors directly into the transfer device. This creates one compact package with no cables or extra parts to carry or potentially lose. The convenience is a defining feature for the target market, and unique in the art.

Using the inventive methods, an accessory with minimal user interface of its own allows direct transfer of content data from one multimedia player to another. As will be readily appreciated by those with skill in the art, the foregoing description is especially well adapted for use with the widely accepted IPOD®. However, the same accessory in used with other portable multimedia players (PMPs) will employ the same inventive methods. Alternative PMPs might include such devices as the Creative Zen Vision M, the Microsoft Zune, and the Toshiba Gigabeat S, the Archos 604 WiFi, the Cowon A3, the Creative Zen Vision W, the SanDisk Sansa View, the Sony PlayStation Portable, and the Philips Portable Media Center. In the case of such alternative PMPs, the user interface techniques and precise role of the communication interfaces will vary.

From the foregoing, it will be appreciated that the preferred embodiments of the present invention may be broadly classified in two categories: Firstly, as a method and apparatus for streaming content from a source multimedia player to one or more destination multimedia players, without saving the content on the destination player or players; and secondly, as a method and apparatus for transferring content from a source multimedia player to one or more destination players and placing and saving the file into memory on the destination player(s).

Accordingly, in its most essential aspect, the inventive system may be characterized as a method and apparatus for streaming and/or transferring data and/or content between a source multimedia player (SMP) and at least one destination multimedia player (DPM). That is, the streaming or transferring can either be point-to-point or point-to-multipoint. An assumption is that the SMP has mass storage for the storage of digital files in one or more of audio, video, digital image, and multimedia formats, and the DMPs either have similar mass storage or means to play streaming content in real time. Whether directed to streaming or to transferring content, the inventive apparatus includes SMP connection means for bringing the inventive apparatus into either wired or wireless communication with the SMP using a selected transfer medium; a user interface and interface and selection software for identifying a content file on the mass storage for extraction; file extraction software for extracting the content file; input hardware for receiving extracted content; formatting or storage software for formatting the extracted content into a format suitable for transmission to a DMP or for storing the content to internal or external flash memory for later transmission to a DMP; transmission hardware for transmitting the formatted content, or transferring the stored content, to the DMP; and DMP connection means for bringing the inventive apparatus into wired or wireless communication with one or more DMPs. Then, in some preferred embodiments, the inventive apparatus further includes transmission mediation software which

Having fully described several embodiments of the present invention, many other equivalents and alternative embodiments will be apparent to those skilled in the art. These and other equivalents and alternatives are intended to be included within the scope of the present invention.

What is claimed as invention is:

1. An apparatus for streaming and/or transferring data and/or content between a source multimedia player and at least one destination multimedia player, wherein the source multimedia player has mass storage for the storage of digital files in one or more of audio, video, digital image, and multimedia formats, and wherein the destination multimedia players either have similar mass storage or means to play streaming content in real time, said apparatus comprising:
source player connection means for bringing said apparatus into either wired or wireless communication with the source player using a selected transfer medium;
input hardware for receiving content data from the source multimedia player;
a transfer CPU having at least an interface;
a user interface for providing input to said CPU;
transmission hardware for transmitting selected content to the destination apparatus; and
destination player connection means for bringing said apparatus into wired or wireless communication with one or more destination multimedia players.

2. The apparatus of claim 1 wherein said apparatus further including a content selection software module.

3. The apparatus of claim 1, wherein said apparatus employs IrDA beaming protocol, and wherein said source player connection means is a high speed data interface, and said apparatus further includes:
transmit/receive software;
an optical IrDA transceiver;
IrDA link access protocol software; and
physical layer software.

4. The apparatus of claim 3, wherein when a user inputs instructions to transfer a file from the source player to a destination player, said content selection software identifies a content file residing on the mass storage of the source player, said interface software extracts the file using said high-speed data interface and passes the content data to said transmit/receive software, which formats it in data packets for the IrDA protocol, and wherein said IrDA link access protocol software identifies a destination player having a clear line-of-sight view of the optical transceiver and establishes a link for transferring the data packets via said physical-layer software and using said IrDA transceiver, and said IrDA link access protocol software establishes the connection and mediates the data transfer to the destination player.

5. The apparatus of claim 4, wherein said interface software also writes the transferred file in the correct directory, with the correct file name in the destination player.

6. The apparatus of claim 5, wherein said interface software further inserts metadata about the transferred file and content in a database on the destination player, such that the destination player will recognize the content file for playback.

7. The apparatus of claim 3, wherein said high speed data interface is selected from the group consisting of USB and RS232.

8. The apparatus of claim 3, wherein said interface software interacts directly with the mass storage on the source player using via a FAT or other filesystem protocol and MSC/MTP or other protocols.

9. The apparatus of claim 1, wherein said selected medium is RF and said content data is modulated onto a radio carrier, and said device further includes:
transmit/receive software;
an RF transceiver.

10. The apparatus of claim 9, wherein said apparatus further includes:
link access protocol software; and
physical layer software.

11. The apparatus of claim 10, wherein said link access protocol software identifies and selects a destination player and establishes a link between the source player and a potential destination player.

12. The apparatus of claim 11, wherein said link access protocol provides a user-interface operation in which the potential destination player is prompted for acceptance of the link, and the user interface displays a list of potential destination players for the user to choose from.

13. The apparatus of claim 12, wherein after said link access protocol software establishes a link between the source player and a destination player, content data is selected and extraction from the source player, formatted in a packet protocol and transmitted to the destination player.

14. The apparatus of claim 1, wherein said apparatus further includes:
link access protocol software; and
physical layer software

15. The apparatus of claim 14, wherein said selected medium is RF streaming, and said device further includes:
transmit/receive software;
an RF transceiver;

16. The apparatus of claim 15, wherein content is extracted from the source player using analog interfaces in the source player and an analog audio path, and is then digitized and formatted as a packet, modulated onto an RF carrier, and transmitted in a broadcast fashion through the RF transceiver.

17. The apparatus of claim 16, wherein said link access protocol software assigns transmitted content to an individual destination player.

18. The apparatus of claim 16, wherein said link access protocol software broadcasts the content on an RF carrier signal to a plurality of potential destination players using either a transparent link access protocol or no protocol.

19. The apparatus of claim 18, wherein said user interface comprises a transmit/receive switch and channel selection.

20. The apparatus of claim 1, further including flash memory storage, a memory bus, and an external USB interface hardware, and wherein said CPU further includes a memory R/W software module, and USB/MSC filesystem software.

21. The apparatus of claim 20, wherein said source player connection means is either a USB or RS232 cable/connector, and wherein content data is extracted from the source player and stored in said flash memory via said memory bus.

22. The apparatus of claim 21, wherein content data stored in said flash memory can be retrieved by said memory R/W software module, and wherein content is transferred to the mass storage of a destination player using said filesystem software and a USB or RS232 cable with a USB or RS232 interface.

23. The apparatus of claim 22, wherein when content is transferred to the mass storage of the destination player, the filesystem software integrates it into the destination player filesystem or database so as to be recognizable and playable by the destination player.

24. The apparatus of claim 1, further including external flash memory.

25. The apparatus of claim 24, wherein said interface and selection software module extract content from the source player, and further including an external USB port and software for a USB flash drive.

26. The apparatus of claim 25, wherein said device employs FAT and MSC or other protocols to interface to the external drive on said USB port.

27. The apparatus of claim 26, wherein to effect content extraction from the source player, a user attaches a USB flash drive to said external USB interface port, selects content data, and initiates content data transfer to said USB flash drive using said user interface, and wherein the transfer of content data entails providing said USB flash drive to another user having a destination player.

28. The apparatus of claim 1, further including software for USB/MSC/MTP or other protocol and filesystem software and USB hardware, and wherein the source player and destination player are simultaneously connected to said apparatus using USB or RS232 cable.

29. The apparatus of claim 28, wherein said interface and selection software module allows user choice of content data to transfer and accesses the content data file through said USB, MSC/MTP or other protocol and filesystem software, and thereafter immediately copies it through said USB hardware to the mass storage of the destination player.

30. The apparatus of claim 1, wherein the selected transmission medium is an RF carrier signal and said transmission hardware is an RF transceiver, and wherein when a user using the user interface selects the transmit mode, said CPU activates the RF transmitter and sets the frequency to a channel set by the user interface.

31. The apparatus of claim 30, wherein analog audio from the source multimedia player headphone or line-out port feeds into the RF modulator in said RF transceiver, and is then transmitted from an antenna.

32. An apparatus for transferring and/or streaming content from a source multimedia player (SMP) to one or more destination multimedia players (DMP), wherein at least the SMP includes mass storage, said apparatus comprising:
SMP connection means for bringing said apparatus into wired or wireless communication with the SMP;
content identification means for identifying and selecting one or more content files in the mass storage of the SMP for extraction;
extraction means for extracting the content files from the mass storage;
content processing means for either selectively formatting the extracted content into a selected transmission protocol or for storing the extracted content in memory;
recipient identification means for identifying a DMP to which to transmit the formatted or stored content; and
transmission means for transmitting the formatted or stored content to the one or more DMPs.

33. The apparatus of claim 32, wherein said content identification means includes a user interface supported by interface and selection software.

34. The apparatus of claim 32, wherein said interface and selection software also functions as said extraction means.

35. The apparatus of claim 34, wherein said interface and selection software passes the extracted content to said content processing means, and wherein said content processing means includes a transmit/receive software module which breaks the content into packets and formats it for the IrDA protocol.

36. The apparatus of claim 35, wherein said recipient identification means comprises IrDA link access protocol software for identifying a DMP in line-of-sight view of said apparatus.

37. The apparatus of claim 36, wherein the packeted content is passed to said transmission means, which comprises physical layer software and an IrDA transceiver having an emitter modulated by said physical layer software.

38. The apparatus of claim 37, further including mediation means for mediating data transfer during transmission from said apparatus to the DMP and stored the transmitted content to memory in the DMP, and further writes a file in the directory of the DMP which includes the correct file name.

39. The apparatus of claim 35, wherein said interface and selection software passes the extracted content to said content processing means, and wherein said content processing means includes a transmit/receive software module which breaks the content into packets and modulates it onto an RF carrier signal.

40. The apparatus of claim 34, wherein said recipient identification means includes link access protocol software which prompts a potential DMP for acceptance of a link.

41. The apparatus of claim 40, wherein the packeted content is passed to said transmission means, which comprises physical layer software and an RF transceiver modulated by said physical layer software.

42. The apparatus of claim 41, further including mediation means for mediating data transfer during transmission from said apparatus to the DMP and stored the transmitted content to memory in the DMP, and further writes a file in the directory of the DMP which includes the correct file name.

43. The apparatus of claim 34, wherein the content is analog audio data and wherein said extraction means is an analog audio path.

44. The apparatus of claim 43, wherein said interface and selection software passes the extracted analog content to said content processing means, and wherein said content processing means includes a transmit/receive software module which breaks the content into packets and modulates it onto an RF carrier signal.

45. The apparatus of claim 44, wherein the packeted content is passed to said transmission means, which comprises physical layer software and an RF transceiver having a modulator which is modulated by said physical layer software.

46. The apparatus of claim 45, wherein said recipient identification means includes link access protocol software which may assign an RF transmission to a selected DMP or broadcast an RF signal to a plurality of DMPs.

47. The apparatus of claim 46, further including software to broadcast the RF transmission using a link access protocol.

48. The apparatus of claim 34, wherein said content identification means includes a user interface supported by interface and selection software.

49. The apparatus of claim 48, further including flash memory and a memory bus, wherein said interface and selection software passes the extracted content to said content processing means, and wherein said content processing means includes a R/W software module for writing the extracted content to said flash memory through said memory bus.

50. The apparatus of claim 49, wherein said SMP connection means is selected from the group consisting of USB and RS232 cable/connector and interface.

51. The apparatus of claim 49, wherein said flash memory is internal flash memory, and wherein said transmission means is selected from the group consisting of USB and RS232 cable and interface, and wherein said apparatus further includes filesystem and protocol software for transferring the extracted content to a DMP and integrating it into the DMP filesystem so as to be recognizable and playable by the DMP.

52. The apparatus of claim 51, further including an external flash memory drive, and wherein said flash memory is external flash memory.

53. The apparatus of claim 48, wherein said transmission means comprises physically sharing said external flash memory with a user of a DMP for selective downloading of the content by the DMP user.

54. The apparatus of claim 32, wherein said SMP includes a headphone port or line-out port, and wherein content identification means and said extraction means include a user interface supported by interface and selection software, and wherein said user interface includes a transmit mode and channel selection means, and wherein said transmission means is an RF transceiver having an RF modulator and an RF antenna.

55. The apparatus of claim 54, wherein said SMP connection means is a wired connection to the SMP headphone port or line-out port, and wherein when said apparatus is connected to the SMP through the headphone or line-out port, and when said transmit mode and a channel are selected by a user through said user interface, said processing means sets a transmission frequency to that selected by said user interface and analog audio from the SMP feeds into said RF modulator in said RF transceiver and is transmitted from said RF antenna.
